(19) United States
(12) Patent Application Publication
(10) Pub. No.: US 2025/0223178 A1
(43) Pub. Date: Jul. 10, 2025

(54) A METHOD OF FORMING AN AEROGEL MATERIAL

(71) Applicant: Krosslinker Pte Ltd, Singapore (SG)

(72) Inventors: Mark Christopher FEARNS, Singapore (SG); Elmira SOGHRATI, Singapore (SG); Kok Jan Edmund TOH, Singapore (SG); Mahesh SACHITHANADAM, Singapore (SG)

(73) Assignee: Krosslinker Pte Ltd, Singapore (SG)

(21) Appl. No.: 18/855,912

(22) PCT Filed: Apr. 12, 2023
(86) PCT No.: PCT/SG2023/050246

§ 371 Date: Oct. 10, 2024

(30) Foreign Application Priority Data
Apr. 12, 2022 (SG) 10202203772X

(51) Int. Cl. C01B 33/158; C01B 33/155; C01B 33/159

(52) U.S. Cl. CPC C01B 33/1585; C01B 33/155; C01B 33/159; C01P 2006/12; C01P 2006/32

(57) ABSTRACT

There is provided a method of making an alkoxy silicate-based aerogel material, the method comprising: hydrolysing an alkoxy silicate in a hydrolytic solvent to form a silica sol for a pre-determined period of time and at a pH of 1-4; mixing the silica sol with a basic solution to form a sol-gel; a first ageing the sol-gel; adding a surface-modifying agent to the sol-gel; a second ageing the sol-gel; and heating the sol-gel at a temperature of 120-250° C. to form the alkoxy silicate-based aerogel material, wherein the alkoxy silicate-based aerogel material has a thermal conductivity of <18 mW/mK. There is also provided an alkoxy silicate-based aerogel material formed from the method.

### TECHNICAL FIELD

The present invention relates to a method of forming an aerogel material.

### BACKGROUND

Conventional methods of forming a silica aerogel involves significantly laborious amounts of washing with alcohols to fully displace residual salt ions from the wet organic aerogel matrix, and cannot produce an aerogel with desired thermal conductivity under ambient drying conditions.

In particular, it is known that TEOS derived aerogels are significantly costlier than waterglass and SiCl₄ derived aerogels, with the additional perceived drawback of requiring lengthy solvent exchange steps and involving copious amounts of organic solvents, which increases costs of production. Additionally, supercritical methods of drying are essential in such methods to obtain the aerogel.

There is therefore a need for an improved method of forming an aerogel material.

### SUMMARY OF THE INVENTION

The present invention seeks to address these problems, and/or to provide an improved method of forming an aerogel material.

In general terms, the invention relates to a method of making an alkoxy silicate-based aerogel material.

According to a first aspect, the present invention provides a method of making an alkoxy silicate-based aerogel material, the method comprising:
hydrolysing an alkoxy silicate in a hydrolytic solvent to form a silica sol for a pre-determined period of time and at a pH of 1-4;
mixing the silica sol with a basic solution to form a sol-gel;
a first ageing the sol-gel;
adding a surface-modifying agent to the sol-gel;
a second ageing the sol-gel; and
heating the sol-gel at a temperature of 120-250° C. to form the alkoxy silicate-based aerogel material,
   wherein the alkoxy silicate-based aerogel material has a thermal conductivity of ≤18 mW/mK.

According to a particular aspect, the silica sol may comprise alkoxy silicate to hydrolytic solvent in a weight ratio of 1:0.8 to 1:1.4.

According to a particular aspect, the hydrolytic solvent may have a surface tension of 20-50 mN/m. The hydrolytic solvent may have a dielectric constant of 15-40.

According to a particular aspect, the pre-determined period of time may be 15-60 minutes.

The basic solution may comprise a mixture of at least a base and a surfactant. In particular, the surfactant may be a cationic, anionic, or nonionic surfactant.

The mixing may be carried out at a temperature of 50-80° C.

The first ageing may comprise adding a dispersing solvent to the sol-gel. In particular, the first ageing may comprise heating the sol-gel at a temperature of 55-65° C. The first ageing may comprise ageing the sol-gel for a period of 2-12 hours.

According to a particular aspect, the adding a surface-modifying agent may cause the sol-gel to become hydrophobic. The adding a surface-modifying agent may comprise adding surface-modifying agent in a ratio of alkoxy silicate to surface-modifying agent of 1:1-1:2.5. Further, the adding a surface-modifying agent may comprise modifying the pH of the sol-gel to a pH of 3-5.

According to a particular aspect, the second ageing may comprise heating the sol-gel at a temperature of 55-65° C. The second ageing may comprise ageing the sol-gel for a period of ≥12 hours.

According to a particular aspect, the heating may comprise drying the sol-gel. In particular, the drying may comprise ambient pressure drying. The drying may be for a period of ≤60 minutes.

According to a particular aspect, the method may not involve undergoing multiple solvent exchange steps.

According to a second aspect, there is provided an alkoxy silicate-based aerogel material formed from the method of the first aspect.

The alkoxy silicate-based aerogel material may be in the form of powder, granules, or a combination thereof. The alkoxy silicate-based aerogel material may have a thermal conductivity of ≤18 mW/mK. According to a particular aspect, the alkoxy silicate-based aerogel material may have a specific surface area of ≥850 m²/g.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings. In the drawings:

FIG. 1 shows an exemplary embodiment of the method of the present invention;

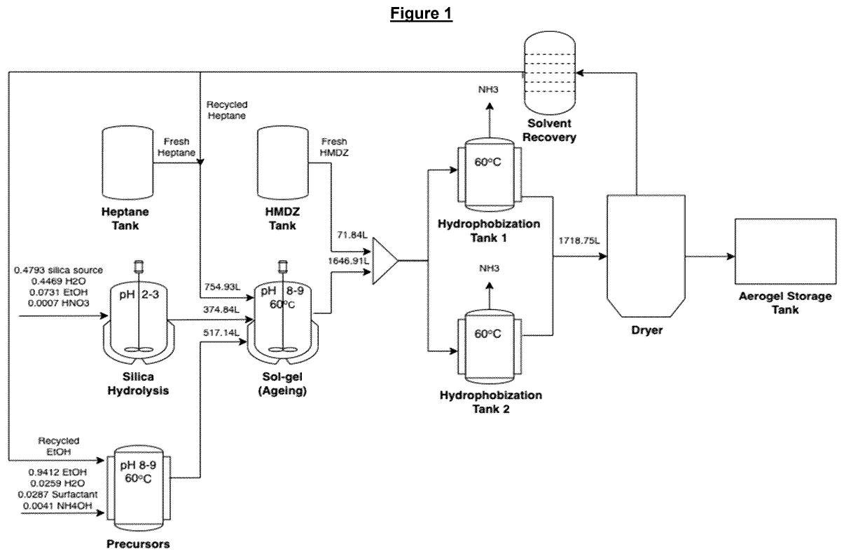

FIG. 2 shows particle size distribution of aerogel powder formed from the present method, for powder sizes up to 100 μm; and

FIG. 3 shows the particle size distribution of granulated aerogels formed from the present method.

### DETAILED DESCRIPTION

As explained above, there is a need for an improved method of forming an aerogel material.

In general terms, the present invention provides an improved method of making an aerogel material. In particular, there is provided a method of making an alkoxy silicate-based aerogel material. The method significantly reduces use of raw materials which leave mineral or salt deposits in the final product, thereby eliminating the need for washing steps. The method may advantageously eliminate the need for solvent exchange, by using miscible solvents with their interfacial surface tension reduced with the use of surfactants, which further reduces the impact of capillary action on the mesoporous structure of the resultant aerogel material. In this way, the need for multiple solvent exchange steps is eliminated, thereby simplifying the process and ultimately saving time and cost. The obtained aerogel materials also exhibit superior quality to other aerogels obtained via ambient drying, supercritical drying and freeze drying technique.

According to a first aspect, there is provided a method of making an alkoxy silicate-based aerogel material, the method comprising:
hydrolysing an alkoxy silicate in a hydrolytic solvent to form a silica sol for a pre-determined period of time and at a pH of 1-4;
mixing the silica sol with a basic solution to form a sol-gel;
a first ageing the sol-gel;
adding a surface-modifying agent to the sol-gel;
a second ageing the sol-gel; and
heating the sol-gel at a temperature of 120-250° C. to form the alkoxy silicate-based aerogel material,
   wherein the alkoxy silicate-based aerogel material has a thermal conductivity of ≤18 mW/mK.

For the purposes of the present invention, an aerogel material may be defined as a material derived from a sol-gel material which may be fabricated when the pore liquid of a wet gel is replaced by air without decisively altering the network structure or the volume of the gel body.

The alkoxy silicate may be any suitable alkoxy silicate. For example, the alkoxy silicate may be, but not limited to, tetramethyl orthosilicate (TMOS), tetraethyl orthosilicate (TEOS), tetrapropyl orthosilicate, methyltrimethoxysilane, methyltriethoxysilane, vinyltrimethoxysilane, vinyltriethoxysilane, 3-glycidoxypropyltrimethoxysilane, 3-glycidoxypropyltriethoxysilane, silicon tetrachloride, phenyltrimethoxysilane, phenytriethoxysilane, or a mixture thereof. In particular, the alkoxy silicate may be TEOS.

The hydrolytic solvent may be any suitable solvent. For example, the hydrolytic solvent may have a low surface tension. According to a particular aspect, the hydrolytic solvent may have a surface tension of 20-50 mN/m at 20° C. In particular, the hydrolytic may have a surface tension of 22-48 mN/m, 25-45 mN/m, 30-40 mN/m, 22-38 mN/m, 25-35 mN/m, 28-30 mN/m. Even more in particular, the surface tension may be 20-25 mN/m.

The hydrolytic solvent may have a low dielectric constant. According to a particular aspect, the dielectric constant may be 15-40. In particular, the hydrolytic solvent may have a dielectric constant of 18-38, 20-35, 22-33, 25-30. Even more in particular, the dielectric constant may be 18-35.

In particular, the hydrolytic solvent may be an alcohol. The alcohol may be any suitable alcohol with at least one —OH functional group. For example, the hydrolytic solvent may be, but not limited to, methanol, ethanol, propanol, butanol, isobutanol, pentanol, hexanol, isopropyl alcohol, tert-butyl alcohol, ethylene glycol, propylene glycol, or a mixture thereof. According to a particular aspect, the hydrolytic solvent may be ethanol.

The hydrolysing may be under suitable conditions. For example, the hydrolysing may be under acidic conditions. In particular, the pH at which the hydrolysing occurs may be 1-4. Even more in particular, the pH may be 2-3.

The pre-determined period of time may be any suitable period of time. For example, the hydrolysing may be for 15-60 minutes. In particular, the hydrolysing may be for 18-55 minutes, 20-50 minutes, 25-45 minutes, 30-40 minutes, 35-38 minutes. Even more in particular, the hydrolysing may be for 29-31 minutes.

The basic solution may be any suitable solution. According to a particular aspect, the basic solution may comprise a mixture of at least a base and a surfactant. The base may be any suitable base such as, but not limited to, ammonium hydroxide, sodium hydroxide, potassium hydroxide, triethylenediamine triethylamine, or a mixture thereof. In particular, the base may be ammonium hydroxide.

The surfactant comprised in the basic solution may be any suitable surfactant. In particular, the surfactant may be a cationic surfactant, anionic surfactant, non-ionic surfactant or a mixture thereof. For example, the surfactant may be, but not limited to, Berol 840, Stepanquat ML, Synperonic PL/64, SPAN 80, Solvay MA-80 I., TWEEN 20, or a mixture thereof.

The mixing may be carried out under suitable conditions. For example, the mixing may be carried out at a suitable temperature. The temperature may be, but not limited to, 50-80° C. In particular, the temperature may be 52-78° C., 55-75° C., 60-70° C., 62-65° C. Even more in particular, the temperature may be 55-65° C., preferably 60° C.

The mixing may result in an increase in the pH followed by gelation, thereby forming a sol-gel. For the purposes of the present invention, the term sol-gel is defined as a network material created by forming sol particles into a gel.

According to a particular aspect, the first ageing may comprise adding a dispersing solvent to the sol-gel. The dispersing solvent may be any suitable solvent. For example, the dispersing solvent may be, but not limited to, Novec 7100, Novec 7200, heptane, hexane, pentane, cyclohexane, octane, cyclopentane, ethoxynonafluorobutane, ethanol, ethylene glycol, propylene glycol, dichloromethane.

The first ageing may be carried out under suitable conditions. For example, the first ageing may comprise heating the sol-gel. The heating may be to a suitable temperature. For example, the heating may be to a temperature of 55-80° C. In particular, the temperature may be 58-75° C., 60-70° C., 62-68° C., 63-65° C.

The first ageing may be for a suitable period of time. For example, the first ageing may comprise ageing the sol-gel for a period of 2-12 hours. In particular, the ageing may be for a period of 3-10 hours, 4-8 hours, 5-7 hours, 6-6.5 hours.

Following the first ageing, a surface-modifying agent may be added to the sol-gel. In particular, the adding causes the sol-gel to become hydrophobic. The adding may comprise adding any suitable surface-modifying agent. For example, the surface-modifying agent may be, but not limited to, trimethylsilylchloride, hexamethyldisiloxane, hexamethyldisilazane, hexaphenyldisiloxane, methyltrimethoxysilane, methyltriethoxysilane, vinyltrimethoxysilane, vinyltriethoxysilane, 3-glycidoxypropyltrimethoxysilane, 3-glycidoxypropyltriethoxysilane, aminopropyltrimethoxysilane, aminopropyltriethoxysilane, trimethylchlorosilane, triphenylchlorosilane, or a mixture thereof.

The adding may comprise adding surface-modifying agent in a suitable amount. For example, the adding comprises adding surface-modifying agent in a ratio of alkoxy silicate to surface-modifying agent of 1:0.5-1:2.5. In particular, the ratio may be 1:0.6-1:2.4, 1:0.7-1:2.3, 1:0.8-1:2.2, 1:0.9-1:2.1, 1:1-1:2, 1:1.1-1:1.9, 1:1.2-1:1.8, 1:1.3-1:1.7, 1:1.4-1:1.6, 1:1.5-1:1.55.

The adding may further comprise modifying the pH of the sol-gel to a pH of about 3-5. The adjustment may be by adding any suitable solvent. For example, the solvent may be, but not limited to, an alcohol. The alcohol may be any suitable alcohol with at least one —OH functional group. In particular, the alcohol may be, but not limited to, methanol, ethanol, propanol, butanol, isobutanol, pentanol, hexanol, isopropyl alcohol, tert-butyl alcohol, ethylene glycol, propylene glycol, or a mixture thereof.

The second ageing may be for a suitable period of time and under suitable conditions. According to a particular aspect, the second ageing may comprise ageing the sol-gel for a period of ≥6 hours, preferably ≥12 hours. In particular, the second ageing may be for a period of 6-48 hours, 12-36 hours, 18-30 hours. Even more in particular, the second ageing may be for 12-36 hours.

The second ageing may comprise heating the sol-gel at a suitable temperature. For example, the heating may be at a temperature of 55-80° C. In particular, the temperature may be 58-75° C., 60-70° C., 62-68° C., 63-65° C.

The heating the sol-gel following the second ageing may be under suitable conditions. For example, the heating may comprise drying the sol-gel. The drying may be any suitable form of drying. According to a particular aspect, the heating may comprise, but is not limited to, ambient pressure drying, supercritical drying, or freeze drying. In particular, the heating may comprise ambient pressure drying.

The heating may be for a suitable period of time. For example, when the heating comprises ambient pressure drying, the heating may be for a period of ≤60 minutes. In particular, the heating may be for 15-60 minutes, 20-55 minutes, 25-50 minutes, 30-45 minutes. Even more in particular, the heating may be for ≤45 minutes.

When the heating comprises supercritical drying, the heating may be for a period of 4-8 hours. In particular, the heating may be for 4.5-7.5 hours, 5-7 hours, 5.5-6.5 hours.

When the heating comprises freeze drying, the heating may be for a period of >20 hours.

According to a particular aspect, the method of the present invention provides a simple method in which the method does not undergo multiple solvent exchange steps. Further, the method may be carried out in a single pot following the mixing, thereby reducing the time of the overall process as well as improve the efficiency of the process for forming the aerogel material.

In particular, the method describes a silica aerogel prepared from a hydrolysable silica-based precursor, derived from an ethanolic sol-gel which uses surfactants and additional organic solvents at a specific ratio to reduce the surface tension of the liquid phase to allow for excellent thermal conductivity of the resultant product through ambient drying.

The formation of a sol-gel is rapid, containing solvents essential in maintaining its structure whilst the silicate groups are developing in molecular weight during the ageing period. Solvents in addition to those contained within the sol-gel matrix may be added to reduce premature evaporation of the primary sol-gel solvents, to facilitate solvent exchange in the event that a solvent with a lower surface tension to the primary sol-gel solvent may be required, and to provide a dispersion medium if agitation is required during ageing. Given that mesoporous materials undergo capillary action upon drying, solvents with minimal surface tension solvents may be selected so as to reduce capillary stresses in line with the Laplace-Young Equation.

Surface modifying compounds may impart a variety of functional properties to the aerogel as well as altering the density of the final product. Surface modifying compounds may take the form of hydrophobic groups designed to reduce aerogel density by reducing surface energy, reducing water retention and thereby improving the thermal conductivity values integral to its application as a thermally insulating material. Surface modifying groups containing any organic moieties are likely to undergo thermal degradation at temperatures lower than the thermal stability threshold of the bulk SiO₂ matrix within a silica aerogel, setting a restriction on the maximum in-service temperature for an aerogel with such surface modifying compounds. It is reported in some prior art that aerogels with terminal trimethylsilyl groups begin to degrade above 250° C., whereas triphenylsilyl terminated aerogels may exhibit surface group temperature stability of up to 500° C.

Aside from hydrophobic but chemically inert surface groups, there is potential for chemically labile functionality to be imparted onto the surface of aerogels, giving the aerogels themselves reactive characteristics similar to polymers. Chemical functionalities include vinyl groups, amines, epoxies, isocyanates, acrylates and others. Commercially available derivatives of alkoxysilicates with the aforementioned chemical functionality allow for incorporation during the initial hydrolysis stage of aerogel synthesis, by undergoing hydrolysis either as the sole silica source or in combination with other tri- and tetra-functional alkoxy silicates such as tetraethyl orthosilicate or methyltrimethoxysilane. The present invention describes the use of at least one such modified alkoxysilicate compound which can impart chemical functionality to aerogel.

The method according to the first aspect differentiates itself from prior art by offering a simplified synthetic process which eliminates the need of costly, time consuming production steps, whilst achieving a product with an exceptionally low thermal conductivity. It offers a process using traditionally more expensive (in contrast to alkali silicates) alkoxy silicate precursors in a 2-pot synthetic procedure free from additional solvent exchange and washing steps, thereby providing a cost reduction in the top-to-bottom process. Surfactants and low surface tension solvents are used to provide in-situ solvent exchange and ageing in a single reactor in a single phase, which when dried under ambient conditions can generate performance properties typically reserved for aerogels dried under supercritical conditions. The process allows for the use of a combination of alkoxy silicate precursors, both tetra- and tri-functional with both chemically labile and inert groups, thus imparting functionality beyond conventional surface hydrophobicity.

According to a second aspect, there is provided an alkoxy silicate-based aerogel material. The aerogel material may be formed from the method described above. The aerogel material may be in any suitable form. For example, the aerogel material may be in the form of powder, granules, or a combination thereof. In this way, transport of the formed aerogel material may be easier.

In particular, the aerogel material may be in the form of powder, and may have any suitable particle size. For example, the aerogel material in powder form may have an average particle size of ≤50 μm. In particular, the aerogel material in powder form may have an average particle size of 5-50 μm, 10-45 μm, 15-40 μm, 20-35 μm, 25-30 μm.

The aerogel material may be in the form of granules, and may have any suitable particle size. For example, the aerogel material in granules form may have an average particle size of >50 μm. In particular, the aerogel material in granules form may have an average particle size of 55-1500 μm, 100-1400 μm, 200-1300 μm, 300-1200 μm, 400-1100 μm, 500-1000 μm, 600-900 μm, 700-800 μm.

The aerogel material may have a low thermal conductivity. According to a particular aspect, the alkoxy silicate-based aerogel material may have a thermal conductivity of ≤18 mW/mK. In particular, the thermal conductivity may be 5-18 mW/mK, 7-15 mW/mK, 8-13 mW/mK, 10-12 mW/mK.

The aerogel material may have a high specific surface area. The alkoxy silicate-based aerogel material may have a specific surface area of >850 m²/g. In particular, the specific surface area may be 850-900 m²/g, 860-890 m²/g, 870-880 m²/g.

The aerogel material may have a t-plot external surface area of ≥1140 m²/g. In particular, the t-plot external surface area may be 1140-1200 m²/g, 1150-1190 m²/g, 1160-1180 m²/g.

The aerogel material may have a suitable pore volume. The pore volume is defined as the total volume of the small openings in a bed of adsorbent aerogel material particles. For example, the pore volume of the aerogel material may be ≥2.5 cm³/g. In particular, the pore volume may be 2.5-3.5 cm³/g, 2.6-3.4 cm³/g, 2.7-3.3 cm³/g, 2.8-3.2 cm³/g, 2.9-3.1 cm³/g.

The aerogel material may have a suitable average pore size. The average pore size is defined as the point in a Brunauer-Emmett-Teller (BET) analysis at which the amount of flow through the sample on the adsorption curve is exactly 50 percent of the amount of flow in a desorption curve, at the same pressure. For example, the average pore size of the aerogel material may be ≥12 nm. In particular, the pore size may be 12.5-16.5 nm, 13-15 nm, 13.5-14.5 nm, 13-14 nm.

Having now generally described the invention, the same will be more readily understood through reference to the following embodiment which is provided by way of illustration, and is not intended to be limiting.

### EXAMPLES

### Materials and Methods

### Example 1

A silica sol was prepared from tetraethylorthosilicate (TEOS) dissolved in ethanol at a weight ratio of about 1.1-1.4:1 with respect to TEOS, hydrolysed with 1.5-2.5 molar equivalents of water under acidic conditions of pH 1-4.

A second solution was prepared from a combination of ethanol, water, ammonium hydroxide and a surfactant. The relative ratio of ethanol, water, ammonium hydroxide and surfactant was 1:0.042:0.028:0.004, respectively, by mass. The ethanolic silica sol contained Solvay MA-801 surfactant to help coordinate the nanoparticle matrix and reduce the surface tension between the several liquid media involved in the synthesis of the aerogel.

After a hydrolysis time of 15-60 minutes, a basic solution was added to the acidic ethanolic sol to modify its pH to a range of 6-8, upon which gelation is typically observed within 180 seconds. The process was kept at 60° C. and under agitation throughout.

After gelation has been observed via a sharp increase in viscosity, a change in optical transmission or other methods, n-heptane was added in a ratio by mass against ethanol of 1.0-1.3:1, to improve dispersibility and reduce the surface tension of the dispersion. The sol-gel dispersion was kept under agitation and heating, also known as ‘ageing’, for a period of between 2-12 hours at a temperature of 55-65° C.

The aged alcogel was then treated with hexamethyldisilazane to impart hydrophobic properties to the alcogel. The hexamethyldisilazane was added at 1.5-2.5 molar equivalents against TEOS, and the pH was modified to an acidic region of 3-5 due to the addition of hexamethyldisilazane. After the addition of the surface modifying compound, the resultant aerogel dispersion was aged further at 60° C. for a period of 12-36 hours, after it was dried at 150° C. to yield the aerogel.

### Example 2

A silica sol was prepared from silicon tetrachloride dissolved in ethanol, at a weight ratio of about 0.9-1.1:1 with respect to SiCl₄, hydrolysed with 1.5-2.5 molar equivalents of water under acidic conditions of pH 1-4.

A second solution was prepared from a combination of ethanol, water, sodium hydroxide (25 wt. % in water), and a surfactant. The relative ratios of ethanol, water, ammonium hydroxide and surfactant was 1:0.042:0.028:0.002, respectively, by mass. The ethanolic silica sol contained Berol 840, a non-ionic surfactant (cationic, anionic and non-ionic), to coordinate the nanoparticle matrix and reduce the surface tension between the several liquid media involved in the synthesis of the aerogel.

After a hydrolysis time of 15-60 minutes, a basic solution is added to the acidic ethanolic sol to modify its pH to a range of 6-8, upon which gelation was observed within 180 seconds. The process was kept at 60° C. and under static conditions (i.e., no agitation) throughout the ageing period.

After gelation has been observed via a sharp increase in viscosity, a change in optical transmission, or other methods, 1-ethyl nonafluorobutane was added at a ratio by mass against ethanol of 2.0-2.5:1 to improve dispersibility and reduce the surface tension of the dispersion. The sol-gel dispersion was kept under agitation and heating, also known as ‘ageing’, for a period of between 2-12 hours at a temperature of 55-65° C.

The aged alcogel was then treated with hexamethyldisiloxane to impart hydrophobic properties to the alcogel, which was added at 1.5-2.5 molar equivalents with respect to SiCl₄, and the pH was modified to an acidic region of 3-5 due to the treatment with hexamethyldisiloxane. After the addition of hexamethyldisiloxane, the resultant aerogel dispersion was aged further at 60° C. for a period of 12-36 hours, after which it was dried at 150° C. to yield the aerogel.

### Example 3

A silica sol was prepared from a combination of tetramethyl orthosilicate and vinyltrimethoxysilane, at a molar ratio of 0.8:0.2, respectively, dissolved in methanol at a weight ratio of about 0.9-1.1:1 with respect to the combined silicates, and hydrolysed with 1.5-2.5 molar equivalents of water under acidic conditions of pH 1-4.

A second solution was prepared from a combination of methanol, water, sodium hydroxide (25 wt. % in water) and a surfactant. The relative ratios of methanol, water, ammonium hydroxide and surfactant was 1:0.042:0.028:0.002, respectively, by mass. The methanolic silica sol contained Solvay MA-80 I, an anionic surfactant to coordinate the nanoparticle matrix and reduce the surface tension between the several liquid media involved in the synthesis of the aerogel.

After a hydrolysis time of 15-60 minutes, a basic solution was added to the acidic methaolic sol to modify its pH to a range of 6-8, upon which gelation was observed within 180 seconds. The process is kept at 60° C. and under static conditions (i.e., no agitation) throughout the ageing period.

After gelation has been observed via a sharp increase in viscosity, change in optical transmission, or other methods, hexane was added at a ratio by mass against ethanol of 1.0-1.5:1 to improve dispersibility and reduce the surface tension of the dispersion. The sol-gel dispersion was kept under agitation and heating, also known as ‘ageing’, for a period of between 2-12 hours at a temperature of 55-65° C.

The aged alcogel was then treated with triemethylchlorosilane to impart hydrophobic properties to the alcogel, which was added at 1.5-2.5 molar equivalents with respect to the combined silicates, and the pH was modified to an acidic region of 3-5 due to the treatment with triemethylchlorosilane. After the addition of the surface modifying compound, the resultant aerogel dispersion was aged further at 60° C. for a period of 12-36 hours, after which the material was dried at 150° C. to yield the aerogel.

### Example 4

A silica sol was prepared from tetramethyl orthosilicate (TMOS) dissolved in methanol at a weight ratio of about 0.9-1.1:1, and hydrolysed with 1.5-2.5 molar equivalents of water under acidic conditions of pH 1-4.

A second solution, was prepared from a combination of methanol, water, ammonium (25 wt. % in water) and a surfactant. The relative ratios of methanol, water, ammonium hydroxide and surfactant was 1:0.042:0.028:0.004, respectively, by mass. The methanolic silica sol contained SPAN80, a nonionic surfactant to help coordinate the nanoparticle matrix and reduce the surface tension between the several liquid media involved in the synthesis of the aerogel.

After a hydrolysis time of 15-60 minutes, a basic solution was added to the acidic methanolic sol to modify its pH to a range of 6-8, upon which gelation was observed within 180 seconds. The process was kept at 60° C. and under agitation throughout the ageing period.

After gelation has been observed via a sharp increase in viscosity, change in optical transmission, or other methods, hexane was added in a ratio by mass against ethanol of 1.0-1.5:1 to improve dispersibility and reduce the surface tension of the dispersion. The sol-gel dispersion was kept under agitation and heating, also known as ‘ageing’, for a period of between 2-12 hours at a temperature of 55-65° C.

The aged alcogel was then treated with hexaphenyldisiloxane to impart hydrophobic properties to the alcogel, which was added at 1.5-2.5 molar equivalents with respect to TMOS, and the pH was modified to an acidic region of 3-5 due to the treatment with hexaphenyldisiloxane. After the addition of hexaphenyldisiloxane, the resultant aerogel dispersion was aged further at 60° C. for a period of 12-36 hours, after which the material was dried at 150° C. to yield the aerogel.

### Characterisation

### Aerogel Tap Density

A 50 mL centrifuge tube was used to measure the tap density of the aerogel particles. The tube was weighed on a balance and recorded (Wₐ). The aerogel particles produced through the methods and processes as described in the Examples 1-4 above were filled into a centrifuge via a spatula. The aerogels were filled to a known volume, for example 25 mL or 40 mL (V) as indicated by the marking on the centrifuge tube. The cap was closed and weighed again on a balance and recorded (W_{b}). The difference in reading is the mass of the aerogels in the centrifuge tube. The tube was then held vertically and tapped on the cover to expel any trapped air in the aerogel and to further compact the particles together. The final volume was read off from the markings on the tube (V_{f}). The density was then calculated as follows:

$$Density = ( {W}_{b} - {W}_{a} ) / {V}_{f}$$

### Thermal Conductivity

Using the heat flow method, HFM 446, a series of systems was employed to investigate the thermal conductivity of aerogel as a granulated bed in different substrates, expressed as both measured and extrapolative values. Aerogel granulated materials are loose and not easily compressed into a uniform structure, typically requiring a mould or mount to hold particles at a set volume and shape, thereby ensuring maximal thermal contact between the particles and the heating plates of the heat flow meter.

The moulds used for the comparison of various kinds of aerogel, via a heat flow meter, are: (i) a 3D-printed box made from ABS polymers, with dimensions of 20×20×1.2 cm; (ii) an extruded polystyrene (XPS) board with a cavity of 1000 mL and dimensions of 20×20×2.6 cm; (iii) an extruded polystyrene (XPS) board with dimensions of 20×20×2.6 cm, and a cavity in the centre of the board holding a volume of 52 mL and dimensions of 10×10×0.52 cm.

For samples where the volume of aerogel produced is small, mould (iii) was used. For larger amounts produced, moulds (i) or (ii) were used.

### Extrapolated Values

Given that the thermal conductivity testing moulds act as a thermal bridge during testing, the measured raw Tc values were higher than the true, intrinsic thermal conductivity of the tested aerogel samples. Outside of relative rank ordering, the measured values could be used to extrapolate the intrinsic thermal conductivity of the test sample by treating a unit test cell as a combination of aerogel plus the substrate, expressed as a volumetric sum of parts:

$${T}_{C} of sample = \frac{Measured {T}_{C} - ( Substrate {T}_{C} \times Substrate Volume Fraction )}{Aerogel Volume Fraction} \qquad ( 1 )$$

### Contact Angle Measurement

The contact angle is defined as the angle between a tangent to the liquid surface and substrate surface at this point. The contact angle of the aerogel was measured via an image software that measures the angle between a surface coated with aerogel particles and a droplet of water. A contact angle of less than 90° will indicate that the substrate surface is hydrophilic. A contact angle greater than 90° will indicate that the substrate surface is hydrophobic. The angle greater than 150° would indicate that the substrate surface is super-hydrophobic.

The surface was treated with aerogel particles, and a droplet of water was then dropped onto the surface. The droplet of water immediately formed a ball. A picture was taken and then uploaded onto an image software to read off the contact angle. The tangent lines were drawn, and the angle formed was measured.

### Particle Size Distribution

Less than 100 μm

The particle size distribution of aerogel powder less than 100 microns was carried out using BetterSizer 2600 instrument, as the particles were too small to be analysed using mechanical sieves. Particle size can be measured by either wet or dry method, using the Bettersizer 2600. With this analyser materials from 0.02 μm to 2600 μm can be characterised easily and accurately. The unit uses laser diffraction technology to precisely measure the particle size in a sample, and Fourier and Reverse Fourier theory to perform the analysis through an integrated software to generate the results quickly.

The aerogels made from the examples can be in the form of granulated particles or powdered particles. The particle size distribution was performed for powder sizes up to 100 microns.

More than 100 μm

Particle size distribution for larger granulated aerogel particles made from the various batches in Examples 1 to 4 was determined in-house, using mechanical sieves. The sieves had standardized sieves of 1000, 700, 300, and 100 microns, stacked in descending order. A volume of aerogel particles was poured onto the largest sieve size. All the sieves were then stacked together with a top lid and mechanically vibrated for 2 minutes. The volume of granulated particles will then fall under the sieving process. The smaller particles fell through the holes of the standard sieves to the bottom tray. After 2 minutes, the mechanical sieving stopped, and the top lid and all the sieves were opened separately. A distribution of aerogel particles was seen in each of the sieves. For example, particles of size range of 700 to 1000 microns were trapped in the 700 micron sieve.

### Brunauer-Emmett-Teller (BET) Surface Area Analysis

Brunauer-Emmett-Teller (BET) surface area analysis is a multi-point measurement of an analyte's specific surface area (m²/g) through gas adsorption analysis, where an inert gas such as nitrogen is continuously flowed over a solid sample, or the solid sample is suspended in a defined gaseous volume. Small gas molecules adsorb to the solid substrate and its porous structures due to weak van der Waals forces, forming a monolayer of adsorbed gas. This monomolecular layer, and the rate of adsorption, can be used to calculate the specific surface area of a solid sample and its porous geometry, thus characterising the nanoporous products.

The sieved particles obtained from Example 1 were analysed for specific surface area and pore size using the instrument TriStar II 3020.

The analysis was carried out to determine the following properties: (i) BET Surface area in m²/g; (ii) T-plot external surface area in m²/g; (iii) pore volume in cm³/g; and (iv) average pore size in nm.

### Results and Discussion

### Example 1

The mould used was mould (iii) and the density calculated as described above.

The thermal conductivity of the mould (iii) with air in cavity was 32.692 mW/mK and substrate volume fraction was set at 80% and aerogel volume fraction was set at 20%, This value remained constant in all the calculations of the Tc of the aerogel samples of Examples 1-4.

TABLE 1
Thermal conductivity and density of aerogels produced in Example 1
Thermal conductivity and Density Data
TC measurements carried out on HFM446 @ 25° C.

| | | | Density |
|---|---|---|---|
| | Measured T_{c} | Aerogel T_{c} | (g/cm³) |
| | (mW/mK) | (mW/mK) | Centrifuge |
| Sample ID | Mould (iii) | Mould (iii) | Tube |
| PDIC-C1 0512021 A | 28.861 | 13.357 | 0.116 |
| PDIC-C1 0512021 B | 29.078 | 14.442 | 0.105 |
| PDIC-C1 MA80 200 mL | 29.060 | 14.352 | 0.109 |

### Example 2

The mould used was mould (iii) and the density calculated as described above.

As mentioned above, the thermal conductivity of the mould (iii) with air in cavity was 32.692 mW/mK and substrate volume fraction was set at 80% and aerogel volume fraction was set at 20%.

The aerogel was synthesised with Solvay Berol 840 as described in Example 2.

TABLE 2
Thermal conductivity and density of aerogels produced in Example 2
Thermal conductivity and Density Data
TC measurements carried out on HFM446 @ 25° C.

| | | | Density |
|---|---|---|---|
| | Measured T_{c} | Aerogel T_{c} | (g/cm³) |
| | (mW/mK) | (mW/mK) | Centrifuge |
| Sample ID | Mould (iii) | Mould (iii) | Tube |
| PDIC-C1Berol 840 200 | 29.060 | 14.352 | 0.1091 |
| mL | | | |
| PDIC-C1Berol 840 1 L | 28.710 | 12.602 | 0.1112 |

### Example 3

The mould used was mould (iii) and the density calculated as described above.

As mentioned above, the thermal conductivity of the mould (iii) with air in cavity was 32.692 mW/mK and substrate volume fraction was set at 80% and aerogel volume fraction was set at 20%.

The aerogel was synthesised with Solvay MA80-I as described in Example 3.

TABLE 3
Thermal conductivity and density of aerogel produced in Example 3
Thermal conductivity and Density Data
TC measurements carried out on HFM446 @ 25° C.

| | | | Density |
|---|---|---|---|
| | Measured T_{c} | Aerogel T_{c} | (g/cm³) |
| | (mW/mK) | (mW/mK) | Centrifuge |
| Sample ID | Mould (iii) | Mould (iii) | Tube |
| PDIC-C1 MA80 200 mL | 29.270 | 15.402 | 0.1103 |

### Example 4

The mould used was mould (iii) and the density calculated as described above.

As mentioned above, the thermal conductivity of the mould (iii) with air in cavity was 32.692 mW/mK and substrate volume fraction was set at 80% and aerogel volume fraction was set at 20%.

The aerogel was synthesised with Solvay SPAN80 as described in Example 4.

TABLE 4
Thermal conductivity and density of aerogel produced in Example 3
Thermal conductivity and Density Data
TC measurements carried out on HFM446 @ 25° C.

| | | | Density |
|---|---|---|---|
| | Measured T_{c} | Aerogel T_{c} | (g/cm³) |
| | (mW/mK) | (mW/mK) | Centrifuge |
| Sample ID | Mould (iii) | Mould (iii) | Tube |
| PDIC-C1 SPAN80 200 | 29.600 | 17.052 | 0.1040 |
| mL | | | |

Comparison with Commercial Aerogels

Moulds (i) and (ii) were used to compare the results of aerogels made from Example 1, in larger sample quantities. The cavities of each of these moulds could minimally fill 1 L of aerogel. The determination of the aerogel thermal insulation was derived from equation (1) provided above.

The thermal conductivity of mould (i) was constant at 78.28 mW/m-K and a volume fraction of 0.905. Mould (ii) was a hollow block, and therefore the reading of the HFM446 was taken directly to be the results of the aerogels under test.

TABLE 4
Thermal conductivity and density of aerogels produced in Example 4
Thermal Conductivity at 25° C. via Heat Flow Method

| | Measured T_{c} | Aerogel T_{c} | Aerogel T_{c} | |
|---|---|---|---|---|
| | (mW/mK) | (mW/mK) | (mW/mK) | Density |
| Sample | Mould (i) | Mould (i) | Mould (ii) | (g/cm³) |
| PDIC-C1 | 21.408 | 15.446 | 19.74 | 0.1082 |
| 110422 | | | | |
| Commercial | 21.42 | 15.94 | 20.22 | 0.0893 |
| Aerogel #1 | | | | |
| (Cabot | | | | |
| Aerogel P300) | | | | |
| Commercial | 25.92 | 20.92 | 23.28 | 0.1280 |
| Aerogel #2 | | | | |
| (JIOS AeroVa) | | | | |
| Commercial | 26.16 | 21.50 | 24.52 | 0.1209 |
| Aerogel #3 | | | | |
| (IBIH KL) | | | | |

Thus, it can be seen that the aerogels produced from the current methods exhibit better thermal insulation against some of the leading commercial aerogels, with at least 25% improvement.

### Contact Angle Measurement

The aerogels were randomly picked from some of the batches made from the Examples 1-4. The aerogels produced shown super hydrophobicity quality with contact angles of around 150°.

### Particle Size Distribution

Less than 100 μm

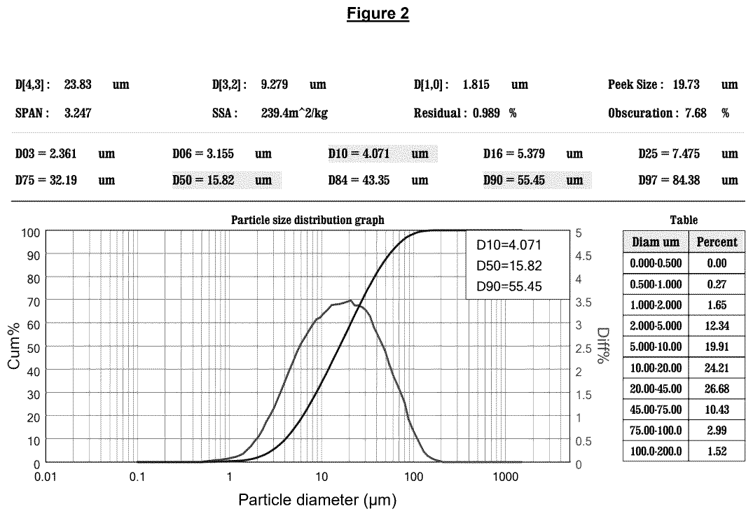

In a sample of aerogel powder made using Example 1, the 90 percentile of the particle size was around 56 microns or less, as seen in FIG. 2.

More than 100 μm

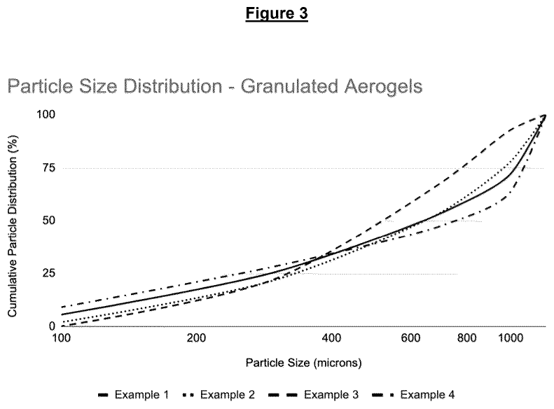

FIG. 3 shows the particle size distribution of the various batches of aerogels made from Examples 1 to 4.

TABLE 5
Particle size distribution of aerogel particles

| Cumulative | | | | |
|---|---|---|---|---|
| Range | Example 1 | Example 2 | Example 3 | Example 4 |
| 1200 | 100.00 | 100 | 100.00 | 100 |
| 1000 | 72.14 | 78 | 92.75 | 63.71 |
| 700 | 53.56 | 54 | 67.95 | 47.58 |
| 300 | 25.70 | 22 | 22.5 | 28.43 |
| 100 | 5.57 | 2 | 0.1 | 9.08 |
| 0 | 0 | 0 | 0 | 0 |

### BET Surface Area Analysis

The following properties are as shown in Table 6: (i) BET Surface area in m²/g; (ii) t-plot external surface area in m²/g; (iii) pore volume in cm³/g; and (iv) average pore size in nm.

TABLE 6
Characteristics of aerogel particles measured by BET

| | | | t-plot | | |
|---|---|---|---|---|---|
| | | | external | | |
| Aerogel | | BET surface | surface area | Pore volume | Average pore |
| particle size | | area (m²/g) | (m²/g) | (cm³/g) | size (nm) |
| <50 | μm | 850.44 | 1147.95 | 3.48 | 16.35 |
| 100 | μm | 865.71 | 1177.69 | 3.40 | 15.71 |
| 300 | μm | 888.58 | 1199.83 | 3.22 | 14.51 |
| 700 | μm | 886.57 | 1196.07 | 3.16 | 14.26 |
| >1000 | μm | 889.29 | 1189.79 | 2.66 | 11.96 |

As seen from Table 6, the t-plot external surface area and the specific surface area obtained for all ranges of particles sizes for the aerogels formed from the present method were higher than those of commercially available aerogels.

Whilst the foregoing description has described exemplary embodiments, it will be understood by those skilled in the technology concerned that many variations may be made without departing from the present invention.

1. A method of making an alkoxy silicate-based aerogel material, the method comprising:
hydrolysing an alkoxy silicate in a hydrolytic solvent to form a silica sol for a pre-determined period of time and at a pH of 1-4;
mixing the silica sol with a basic solution to form a sol-gel;
a first ageing the sol-gel;
adding a surface-modifying agent to the sol-gel;
a second ageing the sol-gel; and
heating the sol-gel at a temperature of 120-250° C. to form the alkoxy silicate-based aerogel material,
wherein the alkoxy silicate-based aerogel material has a thermal conductivity of ≤18 mW/mK.

2. The method according to claim 1, wherein the silica sol comprises alkoxy silicate to hydrolytic solvent in a weight ratio of 1:0.8 to 1:1.4.

3. The method according to claim 1, wherein the hydrolytic solvent has a surface tension of 20-50 mN/m.

4. The method according to claim 1, wherein the hydrolytic solvent has a dielectric constant of 15-40.

5. The method according to claim 1, wherein the pre-determined period of time is 15-60 minutes.

6. The method according to claim 1, wherein the basic solution comprises a mixture of at least a base and a surfactant.

7. The method according to claim 6, wherein the surfactant is a cationic, anionic, or nonionic surfactant.

8. The method according to claim 1, wherein the mixing is carried out at a temperature of 50-80° C.

9. The method according to claim 1, wherein the first ageing comprises: (i) adding a dispersing solvent to the sol-gel; (ii) heating the sol-gel at a temperature of 55-65° C.; and/or (iii) ageing the sol-gel for a period of 2-12 hours.

10. (canceled)

11. (canceled)

12. The method according to claim 1, wherein the adding a surface-modifying agent causes the sol-gel to become hydrophobic.

13. The method according to claim 1, wherein the adding a surface-modifying agent comprises adding surface-modifying agent in a ratio of alkoxy silicate to surface-modifying agent of 1:1-1:2.5.

14. The method according to claim 1, wherein the adding a surface-modifying agent further comprises modifying the pH of the sol-gel to a pH of 3-5.

15. The method according to claim 1, wherein the second ageing comprises; (i) heating the sol-gel at a temperature of 55-65° C.; and/or (ii) ageing the sol-gel for a period of ≥12 hours.

16. (canceled)

17. The method according to claim 1, wherein the heating comprises drying the sol-gel.

18. The method according to claim 17, wherein the drying comprises ambient pressure drying.

19. The method according to claim 17, wherein the drying is for a period of ≤60 minutes.

20. The method according to claim 1, wherein the method does not undergo multiple solvent exchange steps.

21. An alkoxy silicate-based aerogel material formed from the method according to claim 1.

22. The alkoxy silicate-based aerogel material according to claim 21, wherein the alkoxy silicate-based aerogel material is in the form of powder, granules, or a combination thereof.

23. The alkoxy silicate-based aerogel material according to claim 21, wherein the alkoxy silicate-based aerogel material has; (i) a thermal conductivity of ≤18 mW/mK; and/or (ii) a specific surface area of ≥850 m²/q.

24. (canceled)
